(19) United States
(12) Patent Application Publication
(10) Pub. No.: US 2020/0030947 A1
(43) Pub. Date: Jan. 30, 2020

(54) TOOL SET WITH INTERSPERSED DUAL STANDARD ELEMENTS

(71) Applicant: Bennet Karl Langlotz, Dallas, TX (US)

(72) Inventor: Bennet Karl Langlotz, Dallas, TX (US)

(21) Appl. No.: 16/043,294

(22) Filed: Jul. 24, 2018

(51) Int. Cl. B25B 15/00; G09F 3/02

(52) U.S. Cl. CPC B25B 15/008; G09F 2003/0276; G09F 2003/0208; G09F 3/02

(57) ABSTRACT

A tool kit has a first set of tools of a first standard and of different sizes, a second set of tools of a different second standard and of different sizes, and a holder adapted to receive the first and second set of tools intermixed with each other in an integrated sequence arranged according to size irrespective of standard. The different standards may be indicated by different colors or other indicia, or by positions, such as offset rows that preserve the sequence.

### FIELD OF THE INVENTION

This relates to tools, and more particularly to sets of tools having a range of different sizes.

### BACKGROUND OF THE INVENTION

Tools such as Allen wrenches are typically arranged in sets having a sequence of different standard sizes. These sets are typically in a single format or standard, such as matrix or fractional inch. Users will generally require two sets, and these sets segregate the tools of one format from tools of the other format.

Many fasteners do not provide an indication of what size, format or standard they are. A user with an unknown fastener may make a visual estimation of the size of the fastener, and that test a tool. If that is not a fit, the user selects a larger or smaller tool as needed.

While effective, this presents problems when there are two formats of fastener configurations that are not visually evident. In some instances, when the user is attempting to use the wrong tool set format, such as fraction tools for a metric fastener, the use will find after testing multiple tools that none is a fit—all are too large or too small. This indicates that the wrong set is being used, and the user repeats the size selection process with the other format set. This is an annoyance and inconvenience.

A greater risk is that for some tool and fastener sizes, there will be workable but incorrect tool fits. The wrong format tool will be close enough to that of the right format tool that a user may be deceived into thinking it is a correct fit, and never realize that other format set should be used. With the slightly incorrect fit, the tool or fastener may be damaged by the use.

Accordingly, there is need for a tool kit with a first set of tools of a first standard and of different sizes, a second set of tools of a different second standard and of different sizes, and a holder adapted to receive the first and second set of tools intermixed with each other in an integrated sequence arranged according to size irrespective of standard. The different standards may be indicated by different colors or other indicia, or by positions, such as offset rows that preserve the sequence.

### BRIEF DESCRIPTION OF THE DRAWINGS

FIG. 1 shows a tool kit according to a first embodiment of the invention.

FIG. 2 shows a tool holder according to a second embodiment of the invention.

FIG. 3 shows a tool kit according to a third embodiment of the invention.

FIG. 4 shows a tool kit according to a third embodiment of the invention.

### DETAILED DESCRIPTION

FIG. 1 shows an Allen Wrench set 10 including a holder block 12 defining a sequence of passages 14 or graduated sizes in a row arranged by size. The apertures are each sized to removably retain an Allen wrench of a selected size.

A first set of wrenches 20 is a set of a range of different sizes of a first dimensional format or standard, such as Metric, with the wrenches having sizes designated in millimeters.

A second set of wrenches 22 is a set of a range of different sizes of a second dimensional format or standard, such as fractional inch, with the wrenches having sizes designated in fractional inches.

The first set 20 is shown in black and the second set 22 is shown in white as indicia to identity the standard or format associated with each wrench. This indicia may be any visible marking, coloring, or plating, or any attachment such as a handle with a shape color, texture or other indicia to indicate the associated standard or format. The block may also have indicia associated with each aperture to assist in replacing loose wrenches in position.

The wrenches are arranged in sequence by their actual size. For illustration, a limited number of wrenches are shown. Allen wrench sets of metric and fractional standards may typically have the following sizes, arranged in interspersed, integrated, and numerical sequence by actual size regardless of standard:

| metric | fractional | decimal |
|---|---|---|
| (mm) | (in) | (in) |
| 1.5 | | 0.038 |
| | 0.05 | 0.050 |
| 2 | | 0.051 |
| | 1/16 | 0.063 |
| | 2.5 | 0.064 |
| 3 | | 0.076 |
| | 5/64 | 0.078 |
| | 3/32 | 0.094 |
| 4 | | 0.102 |
| | 7/64 | 0.109 |
| | 1/8 | 0.125 |
| 5 | | 0.127 |
| | 9/64 | 0.141 |
| 6 | | 0.152 |
| | 5/32 | 0.156 |
| | 3/16 | 0.188 |
| 8 | | 0.203 |
| | 7/32 | 0.219 |
| | 1/4 | 0.250 |
| 10 | | 0.254 |
| | 5/16 | 0.313 |
| | 3/8 | 0.375 |

The first column represents the metric wrenches of set 20, and the second column represents the wrenches of set 22. These do not necessarily alternate, and there are occasions in which wrenches of the same standard are adjacent in sequence. There are other occasions where wrenches of different standards are very nearly the same, such as the 1/16 inch and 2.5 mm wrenches. In these instances, economy may be achieved by omitting one, and the user seeing a suitable size will naturally select the suitable size even if not officially of the same standard as the fastener.

The user will normally select a wrench that appears to be the correct size for a fastener, and iff too small test larger sizes until the largest one that still fits is found—for female tools like sockets and box wrenches the smallest that fits is selected. In any case the tightest fit is preferred. By sequencing the tools by size the user need not wonder if they could achieve a tighter and more correct fit in a wrench set of the other standard, nor does the user who tests and finds the tightest of each standard need to qualitatively estimate which is actually the tighter fit. With the illustrated embodiment it is readily established which is the tightest fit by the one that still fits and is one size smaller than—adjacent in the sequence to—the smallest one that does not fit.

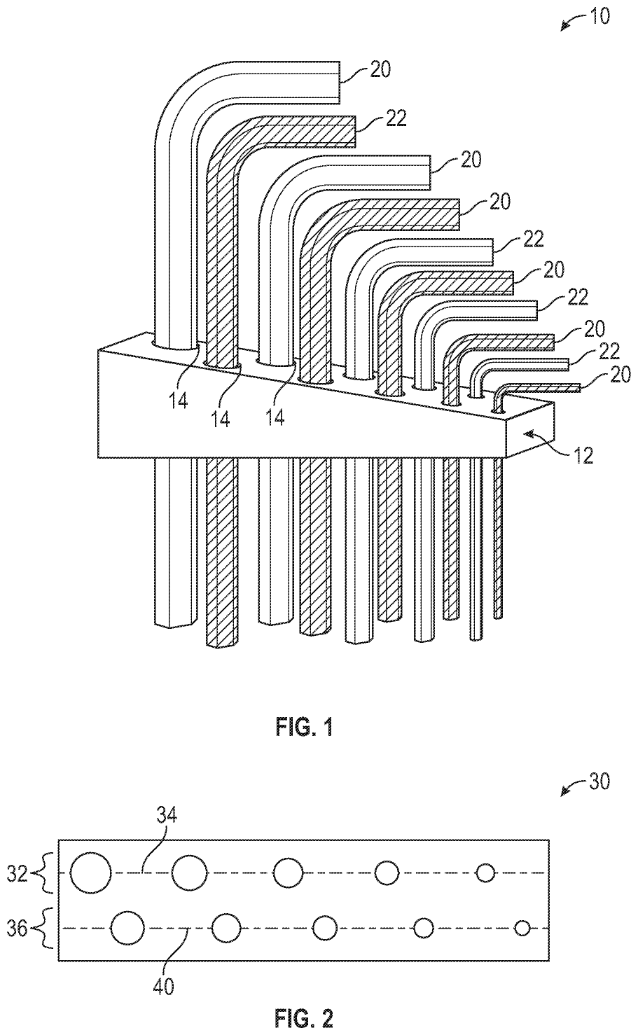

FIG. 2 shows an alternative storage block 30 in which the graduated-size apertures that receive the tools are arranged in size sequence along the length of the block, but in rows that are offset from each other. The spaces 32 for metric tools are in a first row 34, and the spaces 36 for fractional tools are in a second row 40 offset from the first. This is analogous to black keys and white keys on a piano keyboard that are arranged sequentially by pitch but with offset striking surfaces.

The offset rows is only one example of how the storage black may indicate the format or standard of the wrenches without disrupting the size sequence and integrated and interspersed quality. Alternatives include having each region associated with a standard in a color, texture or other quality that is distinguished from the other standard's region. This quality may be associated with the distinctive indicia of each set of wrenches, such as having a darker block region associated with the wrenches of a standard that is indicated by plating or coating of a darker color. This facilitates the returning of tools to their proper apertures, especially when tools of different standards may be very similar in size. An alternative or additional indicator of the different standard region is elevating one portion to a different level.

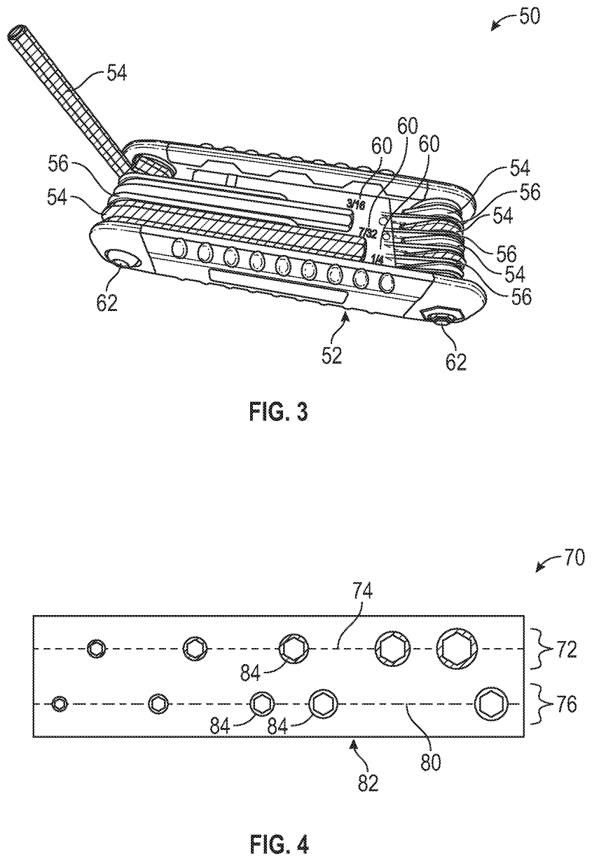

FIG. 3 shows a compact Allen wrench set 50 with wrenches attached to a handle 52 and having a folding capability. This is a conventional format and structure for single standard wrench sets but is assembled with the wrenches of two different standard formats 54, 56 integrated according to the principles of the invention. The wrenches or handle may be provided text markers 60 indicating size, and the wrenches are colored or provided with visual indicia to indicate their standard format.

The use of indicia for standard indication is useful not only for replacing tools in a proper location—not a concern in this embodiment in which tools are captured with loop ends receiving pivot pins 62 on the handle, but also for users who know what format their project or fastener requires and can avoid testing tools of the wrong format.

FIG. 4 shows a socket tool kit 70 having a first set 72 of metric sockets of a first color arranged on a first line 74, and a second set 76 of fractional sockets arranged in a second line 80 offset from the first line 76. As with other embodiments, the sockets are provided with indicia to indicate their standard format. The sockets are held in a housing or tray 82 defining apertures 84 in the illustrated arranged, and the apertures are sized to closely receive only the correct size socket. Tools of any type that come in sizes, such as box wrenches and drill bits may be fabricated and housed according to these principles.

In addition, because users may have existing tool sets of both formats, there may be a need for storage blocks or cases that simply arrange existing tools in a more convenient way. These storage facilities may include bench blocks designed to rest on a workbench, tool holders of the types illustrated above but without the tools included, and any other type of toll storage facility having a position or location sized, shaped, or arranged to accept a certain tool size.

I claim:

1. A tool kit comprising:
a first set of tools of a first standard and of different sizes;
a second set of tools of a different second standard and of different sizes;
a holder adapted to receive the first and second set of tools intermixed with each other in an integrated sequence arranged according to size irrespective of standard.

2. The tool kit according to claim 1, wherein the first set of tools have a first indicia, and the second set of tools have a second indicia visually distinct from the first indicia, such that a user may identify a standard associated with each tool.

3. The tool kit according to claim 2, wherein the first indicia and second indicia are different colors.

4. The tool kit according to claim 2, wherein the first indicia and second indicia are different coatings.

5. The tool kit according to claim 1, wherein tools of the first set have a first visual characteristic in common and tools of the second set have a second visual characteristic distinguishable from the first visual characteristic in common.

6. The tool kit according to claim 1, wherein the holder is a body defining a plurality of apertures, each aperture sized to receive a selected tool.

7. The tool kit according to claim 1, wherein the tools are connected to the holder and each tool is movable between a stowed position and an operating position.

8. The tool kit according to claim 6, wherein the tools each define an aperture, and the holder defines a shaft, the apertures receiving the shaft with the tools arranged along the shaft.

9. The tool kit according to claim 1, wherein the tools are wrenches.

10. The tool kit according to claim 1, wherein the tools are Allen wrenches.

11. The tool kit according to claim 1, wherein the holder defines positions for the first set of tools in a first location and defines positions for the second set of tools in a visually distinct second location.

12. The tool kit according to claim 11, wherein the tools are arranged by size along one axis and the sets are offset from each other in different rows.
